(19) United States
(12) Patent Application Publication
(10) Pub. No.: US 2025/0167610 A1
(43) Pub. Date: May 22, 2025

(54) ROTOR FOR A ROTARY ELECTRIC MACHINE

(71) Applicant: NIDEC PSA EMOTORS, CARRIERES SOUS POISSY (FR)

(72) Inventors: Olivier GAS, VERSAILLES (FR); Diana FANTUZ, PLAISIR (FR); Andrei DARABANA, VILLENNES SUR SEINE (FR); Francois TURCAT, MONTIGNAC SUR CHARENTE (FR)

(21) Appl. No.: 18/839,384

(22) PCT Filed: Feb. 6, 2023
(86) PCT No.: PCT/FR2023/050156

§ 371 Date: Aug. 16, 2024

(30) Foreign Application Priority Data
Mar. 29, 2022 (FR) FR2202832

(51) Int. Cl. H02K 1/276; H02K 15/027; H02K 15/035

(52) U.S. Cl. CPC H02K 1/276; H02K 15/027; H02K 15/035

(57) ABSTRACT

A rotor (30) for a rotary electric machine, comprising:-at least one permanent magnet (1),-a rotor mass (33) comprising laminations stacked on top of one another, comprising at least one housing (4) accommodating the permanent magnet (1), the housing (4) being delimited by at least one large face (5a) facing a long side (2a) of the permanent magnet (1), at least one lamination (6) comprising at least two cutouts (10) between them creating at least one tab (12) meeting said large face (5a) of the housing (4) and extending into the housing (4), notably in the direction of the air gap, the lamination (6) comprising one or more punches (15) formed in the tab or tabs (12) and enabling the permanent magnet (1) to be held against an opposite face (6b) of the housing (4).

### CROSS-REFERENCE TO RELATED APPLICATIONS

This application is the US National Stage under 35 USC § 371 of International Application No. PCT/FR2023/050156, filed Feb. 6, 2023, which claims the priority of French application 2202832 filed on Mar. 29, 2022, the content (text, drawings and claims) of both said applications being incorporated by reference herein.

### BACKGROUND

The present devices and methods relate to rotary electric machines and, more particularly, to the rotors for such machines. They also relate to permanent-magnet rotors.

More particularly, they relate to synchronous or asynchronous AC machines. In particular, they relate to traction or drive machines for electric motor vehicles (Battery Electric Vehicles) and/or hybrid motor vehicles (Hybrid Electric Vehicles-Plug-in Hybrid Electric Vehicles), such as private cars, vans, trucks or buses. They also apply to rotary electric machines for industrial and/or power generation applications, in particular naval, aerospace or wind turbine applications.

Permanent-magnet rotors are generally composed of a rotor body and of permanent magnets of various geometric shapes.

The rotor body may comprise a stack of cut, thin magnetic laminations. It may comprise one or more stacks of laminations stacked one on top of the other.

The permanent magnets may be arranged on the surface, directly facing the air gap or, alternatively, be arranged inside the rotor mass, in housings therein, then being said to be “buried” or “embedded”.

In this case, it is necessary to radially and/or axially lock the permanent magnets in their housings, and this locking has to be sufficient to avoid damaging the permanent magnets and allow the rotary electric machine to operate correctly. Indeed, in the event of insufficient wedging in place, the permanent magnets may be subject to micromovements, which may lead to the destruction thereof, to the deterioration of the electrical and magnetic performance of the machine, and to balancing faults.

To secure the magnet in its housing, multiple techniques are currently applied, such as the use of claws, shim(s), adhesive, a matching specific magnet and housing shape, for example the use of magnets having a trapezoidal cross section, or impregnating the magnet in its housing after it has been put in place.

However, these techniques have certain drawbacks. They can be difficult and expensive to implement.

The use of an intermediate part such as a shim implies additional costs and can complicate the manufacturing process.

The use of claws is not suitable for certain types of permanent magnets, which may suffer from scratching.

The bonding of the magnets into their recesses is a lengthy process which generally requires a heating operation followed by a cooling operation. The bonding of the magnets may also entail leakages, which affects the cleanliness of the parts and makes the production of the machine more complex. In addition, the bonding of the magnets involves a risk of variation in positioning between the different magnets for one and the same stack of laminations as well as between stacks if the magnets are not preset in place before the bonding step. Lastly, the bonding may present a problem in terms the assembly's service life for certain applications, and makes it practically impossible to recover the magnets without damage.

Regarding impregnation, this is a lengthy, expensive and space-demanding process in terms of implementation, given the need to use impregnation tanks and ovens. Furthermore, this involves thermal stress which may risk demagnetization of the magnets and likewise makes it impossible to recover the magnets without damage.

Additionally, in order to improve the cost and performance of electric machines, it may be necessary to increase the quantity of magnets, in particular when it is not possible to improve their quality, or to retain the same level of performance with less expensive magnets of lesser quality.

Optimal electromagnetic performance is obtained when a buried magnet—which has, in cross section, two short opposing sides and two long opposing sides—is in perfect contact on one or both of its two long opposing sides with the stack of laminations in which it is buried, with the flow of the magnetic flux from the magnets to the stack of laminations being maximized.

However, there is generally a clearance between the magnets and their recesses in the stack of laminations into which they are inserted, thus forming an air gap from a magnetic point of view which inevitably causes losses in the electromagnetic performance of the machine. Such a clearance is related to production constraints which do not make it possible, at reasonable cost, to observe very precise dimensions in the cutting out of the laminations or in the design of the magnets. A clearance may also be due to the fact that since the magnets are susceptible to corrosion, it may be necessary to cover them with a protective coating which also leads to uncertainty in their dimensions.

Furthermore, mounting constraints require a certain degree of clearance to be maintained between the magnets and the recesses in the stack of laminations so as to facilitate the insertion of the magnets thereinto, in particular when the stack of laminations is formed of a stack of thin magnetic laminations. Indeed, in this case, the walls of the stack of laminations may not be perfectly straight given the fact that they are made up of a stack of thin laminations, which may require an even greater clearance for mounting.

In the case where the machine comprises multiple magnets arranged in multiple rows per pole in the stack of laminations, the sets of magnets of the different rows add up and accordingly weaken the magnetic performance of the machine.

Furthermore, the use of bendable tongues can lead to a risk of incipient tongue breakage and breakage thereof.

In international application WO 2022/029053, the permanent magnets are locked by bendable tongues.

International application WO 2022/029058 relates to a rotor in which the magnets are locked by two punches.

In application EP 3 890 162, the laminations comprise protrusions and openings arranged in the vicinity of the protrusions in order to allow the deformation of bridges of material extending between the protrusions and the openings, so as to lock the permanent magnets. There are no punches as disclosed herein.

In application US 2021/0028662, some of the laminations comprise generally non-symmetrical triangular lockers, which are positioned on the sides of the permanent magnets so as to lock them. These lockers are not punches.

In applications DE 10 2017 210879, EP 3 611 824 and EP 3 695 486, the magnets are held in place by tongues. There is no punch.

In DE 10 2020 102457, the laminations comprise openings in order to allow the deformation of bridges of material extending over the openings, so as to lock the permanent magnets. There are no punches.

Finally, in JP 2012 244677, an elastic body insert placed in a groove in the lamination is used.

There is a need to improve magnetic performance and to decrease the costs in producing and assembling rotary electric machines.

### SUMMARY

The described methods and devices aim to address this need and one subject matter thereof, according to one of its aspects, is therefore a rotor for a rotary electric machine, comprising:
at least one permanent magnet that has, in cross section, perpendicular to an axis of rotation of the rotor, at least one long side and at least one short side,
a rotor mass comprising laminations stacked on top of one another, the rotor mass comprising at least one housing accommodating the permanent magnet, the housing being delimited by at least one large face facing a long side of the permanent magnet, at least one lamination comprising at least two cutouts between them creating at least one tab meeting said large face of the housing and extending into the housing, in particular in the direction of the air gap,

the lamination comprising one or more punchings arranged in the tab or tabs and enabling the permanent magnet to be held against an opposite face of the housing.

“Punch” is intended to mean a deformation of the lamination, which is convex toward the inside of the housing, in particular on a large face of the housing. This is a local deformation of the lamination oriented in the housing. The punch or punchings may enable the permanent magnet to be held against the opposite face of the housing.

The punch is not a through-punch; it is different from an opening in the lamination. The amount of material moved is thus reduced, which facilitates the movement thereof. The orientation of the movement of the material is also more precise.

When the face of the housing comprises two punchings that are convex toward the interior of the housing, the punchings may be positioned on the face of the housing so as to face the first and second thirds of the long side of the magnet, respectively.

When moving parallel to the permanent magnet at a punch, a free space created by the cutout or cutouts may be encountered.

The tab or tabs are not deformable, they do not bend, and in particular they cannot deform outside the plane of the lamination when the permanent magnets are inserted into the rotor mass. The tab or tabs can be configured so as not to be deformed outside the plane of the lamination during the rotation of the rotor.

The tab or tabs may not be in contact with the corresponding permanent magnet before forming the punch. Before forming the punch, there may be some clearance between the tab or tabs and the permanent magnet.

Each tab may comprise a punch, in particular a single punch. The punch may be centered on the tab, in particular between the two cutouts that create the tab.

The tab or tabs may be integral with the rest of the lamination.

The cutouts make it possible to facilitate and delimit the deformation of the lamination due to the punch and to orientate the lamination, favoring a radial deformation thereof, in particular the deformation of the lamination toward the inside of the corresponding housing. Additionally, the creep of material due to the punch is facilitated. Improved locking of the permanent magnets is thus obtained.

Thus, better clamping of the permanent magnet is obtained, for a given punch depth. This also makes it possible to bridge a larger clearance between the face of the housing and the permanent magnet.

The punching force can also be lower for a given clamping of the permanent magnet, which can make it possible to reduce the number of punchings to be performed and thus the capacity of the punching press.

When the rotor is viewed along an axis of rotation X, the tab or tabs may not be superimposed with a permanent magnet, as opposed to a tongue, in particular a deformable tongue intended to deform when the permanent magnet is inserted.

When the rotor mass comprises one or more laminations without cutouts and tabs, the tab or tabs can be superimposed with such a lamination. In other words, the tab may not protrude from a lamination without a tab and a cutout, unlike a tongue, in particular a deformable tongue intended to deform when the permanent magnet is inserted.

Alternatively, the tab can protrude from a lamination without a tab, and be accommodated in a groove arranged in the corresponding permanent magnet.

The presence of the tab, cutouts and punch makes it possible to avoid the use of adhesive. It may also be a complement to bonding, which can make it possible to position the magnet prior to bonding. It can make it possible to minimize both micromovements of the permanent magnet in the recess and therefore the risk of the permanent magnet cracking, and vibrations of the permanent magnet in the recess and therefore noise.

### SUMMARY

### Tabs and Cutouts

The tab or tabs can be symmetrical in shape with respect to an axis of symmetry, in particular an axis of elongation of the tab. The symmetry of the tab allows better control of the deformation thereof during punching.

The cutout may take any shape, for example a rounded or non-rounded shape, an angled shape, in particular a square, rectangular, triangular shape, or correspond to a longitudinal notch.

In particular, the cutout can be symmetrical with respect to an axis of symmetry, in particular an axis of elongation of the cutout.

A cutout can have a width that is dependent on its length. A ratio of the width l of a cutout to its length L can be comprised between 1 and 2, better still between 1.1 and 1.9, even between 1.2 and 1.8, or even between 1.3 and 1.7, being for example of the order of 1.5.

The bottom of a cutout can have a rounded shape, for example, an arc of circle. The radius of curvature may, for example, be of the order of the thickness e of the corresponding lamination. The radius of curvature may be greater than or equal to 0.3 mm. For example, in the case of a lamination with a thickness of 0.35 mm, the radius of curvature can be 0.35 mm.

In one embodiment, the cutout or cutouts can be generally V-shaped, with a rounded bottom. The rounding may have a radius of curvature comprised between 0.1 and 2 mm, better still between 0.2 and 1 mm, or even between 0.3 and 0.4 mm, for example being 0.35 mm.

The tab or tabs may comprise a flat area at the free end thereof. Alternatively, the tab or tabs may have a rounded shape at the free end thereof.

A distance d between the edge of the tab, in particular at the flat area, and the edge of the punch, may be comprised between 0.3 and 0.7 mm, better still between 0.4 and 0.6 mm, being for example of the order of 0.5 mm.

The half-width B of a tab, corresponding to the distance between the center of the tab and the edge of the cutout, may be greater than a radius R of the punch plus 1.5 times the thickness e of the lamination. This can be written as follows: B>R+1.5 e.

The half-width B of a tab may be comprised between 0.8 and 2.5 mm, better still between 1.0 and 2.0 mm, being for example of the order of 1.5 mm. The width of a tab may be comprised between 1.8 mm and 5 mm, better still between 2 mm and 4.05 mm, being for example of the order of 3 mm or 2.55 mm.

An angle C between the line parallel to the edge of the flat area of the tab passing through the center of the punch and the tangent to the bottom of the cutout passing through the center of the punch can be greater than or equal to 0°. The angle C may be comprised between 0° and 90°, better still between 10° and 50°, or even between 20° and 40°, being for example of the order of 30°.

The tab or tabs can be positioned at the center of a face of the corresponding housing, in particular at the center of a large face of the corresponding housing.

The lateral housings may comprise a single tab. The lateral permanent magnets can be held in place with a single punch.

The central housing of one housing row may comprise a single tab. The permanent magnet in the middle of the row can be held with a single punch.

Alternatively, one face of the housing may comprise two tabs, which in this case can be located at approximately one-third and two-thirds of the length of the face of the housing.

As a further alternative, one face of a housing may comprise three tabs.

In one embodiment, the central housing of one housing row may comprise two tabs. The two tabs may be separated by a cutout wider than the lateral cutouts. In this way, the permanent magnet in the middle of the row is held in place with two punches, which makes it possible to improve its hold and adapt to the positioning of the magnet, while minimizing the magnetic impact.

In addition, the lamination may comprise one or more punches arranged in a short side of a housing, in particular a central housing and/or a lateral housing. In this way, the corresponding permanent magnet can be locked by two punches, one positioned on the long side of the magnet and the other on the short side of the magnet. For example, the punching of at least one of the short sides of the central magnet makes it possible in a repeatable manner to systematically press the magnet on the same side, and thus to reduce the unbalance variation generated by the uncertainty in the positioning of the magnets.

### Groove

At least one permanent magnet may comprise a groove, in particular over the entire length thereof, intended to accommodate one or more tabs of laminations of the rotor mass. In this configuration, the cutouts are arranged on either side of the tab over all or almost all the length of the housing, and the tab protrudes from a large face of the housing. In particular, the groove can be arranged on a long side of the permanent magnet, in particular opposite the air gap. The groove of the permanent magnet extends longitudinally, parallel to an axis of rotation of the rotor.

This configuration is advantageous in that the punch arranged in the tab can make it possible to hold the permanent magnet in three different directions, namely a first direction pushing the permanent magnet toward the air gap, and additionally two directions perpendicular to the first direction, with a possible deformation of the tab on three sides thereof.

There is no deformation or bending of the tab when the corresponding permanent magnet is inserted, and some clearance may remain between the tab and the permanent magnet in the groove thereof before the punch.

During the punching, a deformation of the tab material around the punch is obtained, which can bridge the clearance between the tab and the permanent magnet, and immobilize the magnet.

### Permanent Magnets

The cross section of a permanent magnet is perpendicular to an axis of rotation of the rotor.

The permanent magnet may have a first short side and a second short side, opposite the first side. The permanent magnet may have, in cross section, a first long side and a second long side, opposite the first side.

The permanent magnets may have a generally rectangular cross section. In particular, they may not have a generally trapezoidal cross section. Such a shape can be more standard, and therefore less expensive.

The rotor may comprise buried permanent magnets. The permanent magnets may not be arranged circumferentially. They may not be arranged on the surface of the rotor mass.

The rotor mass may comprise permanent magnets arranged obliquely with respect to the air gap. Alternatively, the rotor mass may comprise permanent magnets arranged tangentially with respect to the air gap.

They may be arranged in one or more rows, in particular in a U-shape or a V-shape. The permanent magnets may be arranged in one, two, three or more rows.

In one embodiment, the housings of one pole can be arranged in first and second rows of housings, the second row possibly being closer to the air gap than the first row. The first row of housings may comprise three housings arranged in a U-shape, with one central housing and two lateral housings. The housings of the second row can be arranged in a V-shape.

Each housing of the lamination may have one or two tabs. In one embodiment, each housing forming the lateral arms of a U or a V may comprise a single tab. Each housing forming the bottom of a U may comprise one or two tabs.

The rotor may comprise permanent magnets arranged to form poles of the rotor. The cutouts and/or the punches of one pole of the rotor may be arranged symmetrically with respect to one another.

The permanent magnets may be coated with an encapsulating material, which may advantageously be ductile. A ductile coating can ensure that the magnet is held securely and does not generate pollution from chips, dust or other residues, which would, for example, be a disadvantage in a liquid-cooled machine.

### Tongues

At least one lamination may comprise at least one deformable tongue.

The tongue may be connected to a large face of the housing, for example between two tabs.

Since the housing is delimited by at least one large face facing a long side of the permanent magnet, at least one lamination may comprise at least one tongue connecting to a large face of the housing and extending into the housing, in particular in the direction of the air gap, the tongue or tongues allowing the permanent magnet to be held against an opposite face of the housing.

The tongue makes it possible to favor correct positioning of the permanent magnet.

In the case that the lamination comprises such a tongue, it may be advantageous for the lamination to comprise two tabs, one on either side of the tongue.

Alternatively or additionally, the tongue may be connected to a small face of the housing and extend into the housing, in particular in the direction of the air gap, the tongue or tongues making it possible to hold the permanent magnet against an opposite face of the housing.

Said small face is opposite a short side of the permanent magnet.

The tongue or tongues overlap slightly with the corresponding permanent magnet, allowing a slight deformation of the tongue when the permanent magnet is inserted into its housing, and a wedging thereof by compression. The tongue or tongues are deformable, and may deform outside the plane of the lamination when the permanent magnets are inserted into the rotor mass. The deformable tongue or tongues may comprise a bendable portion that is configured to be bent outside the plane of the lamination so as to press against the short side of the permanent magnet.

The tongue or tongues may not bend completely when the corresponding permanent magnet is inserted. On the other hand, the tongues may deform outside the plane of the lamination of the rotor mass when the corresponding permanent magnet is inserted.

The tongue or tongues may be configured to push the permanent magnets in the direction of the air gap. The tongue or tongues may be configured to push the permanent magnets toward the outer diameter of the rotor. Such pushing is advantageously the same as that caused by the effect of the centrifugal force on the permanent magnets. The tongues may not be configured to push the permanent magnets in the direction of the axis of rotation of the rotor. In particular, the tongues may not be oriented toward the inside of the rotor, but rather toward the outside thereof.

The deformable tongue may allow the permanent magnet to be mechanically locked in the housing when it is inserted into the housing and/or during the operation of the machine when the permanent magnet is in place in the housing. The tongue may thus allow the permanent magnet to be pre-positioned and/or held in the housing, in particular during the operation of the machine.

The permanent magnet having, in cross section, a first short side and a second short side, opposite the first, the tongue may be configured to press against the first short side of the permanent magnet, at least one lamination comprising at least one stop facing the second short side of the permanent magnet.

### Laminations

In one embodiment, all the laminations of the rotor mass comprise cutouts and tabs. Therefore, the laminations of the rotor mass may be identical to each other.

Alternatively, the rotor may also comprise laminations without cutouts or tabs. The laminations provided with cutouts and tabs can, in particular, be arranged at one or both axial ends of the rotor mass. The laminations without cutouts and tabs can be arranged at the middle of the rotor mass, between two sets of laminations provided with cutouts and tabs. The laminations with cutouts and tabs can be arranged at either end of the stacks of laminations of the rotor. This makes it possible to ensure that the magnets are held securely in each stack of laminations of the rotor by punching.

In particular, a rotor mass may comprise 5 to 30% of laminations comprising cutouts and tabs n. For example, the rotor mass may comprise at least two laminations comprising cutouts and tabs, and in particular three, four or five laminations comprising cutouts and tabs.

One and the same lamination of the rotor mass may comprise multiple cutouts, each tab being in particular formed in said lamination and being in particular integral with the rest of said lamination. Said lamination may comprise multiple housings and one or two tabs per housing. The rotor mass may then comprise both laminations comprising multiple housings and one or two tabs per housing, and laminations without tabs and cutouts.

The laminations may comprise a housing extending from the lateral housing to the central housing. The notch may be configured to protrude radially from the central recess. The notch may have an edge that extends at least partially parallel to an edge of the central recess.

### Machine

Another subject is a rotary electric machine, comprising a stator and a rotor as defined hereinbefore.

The machine may be used as a motor or as a generator. The machine may be a reluctance machine. It may be a synchronous motor or, alternatively, a synchronous generator. Alternatively still, it is an asynchronous machine.

The maximum rotational speed of the machine may be high, for example higher than 10,000 rpm, better still higher than 12,000 rpm, for example of the order of 14,000 rpm to 15,000 rpm, or even 20,000 rpm or 24,000 rpm or 25,000 rpm. The maximum rotational speed of the machine may be lower than 100,000 rpm, or lower than 60,000 rpm, or even lower than 40,000 rpm, better still lower than 30,000 rpm.

The described methods and devices may be most particularly suitable for high-power machines.

The machine may include a single inner rotor or, alternatively, an inner rotor and an outer rotor, which are arranged radially on either side of the stator and are rotationally coupled.

The machine may be placed into a casing on its own or inserted in a gearbox casing. In this case, it is placed in a casing that also houses a gearbox.

The machine includes a stator. The stator includes teeth which define slots between them. The stator may include electrical conductors, and at least some of the electrical conductors, or even most of the electrical conductors, may be in the form of U-or I-shaped pins.

### Production Methods

Another subject is a method for producing a rotor for a rotary electric machine as defined hereinbefore. The method may comprise the step of longitudinally inserting, along the axis of rotation of the rotor, at least one permanent magnet into the recess.

Another subject is, independently or in combination with the foregoing, a method for manufacturing a rotor of a rotary electric machine, comprising the following steps:
(a) providing a rotor mass of the rotor comprising housings into which one or more tabs extend each arranged between two cutouts,
(b) inserting permanent magnets into the housings of the rotor mass of the rotor, the tabs not being deformed during this insertion, and
(c) forming one or more punches in the tab or tabs in order to hold the permanent magnet against an opposite face of the housing.

The permanent magnet may be introduced, magnetized or unmagnetized, into the housing, along the axis of rotation of the rotor.

The punching can be performed by means of a punch tool, the shape of which can be selected from the following list, which is not exhaustive: cylindrical, sharp-edged or spherical, half-cylinder with the cylindrical part facing the housing side. A cylindrical shape makes it possible advantageously not to have to orient the punch tool. A spherical cylindrical shape can make it possible to move less material than a cylindrical shape with a sharp edge, with constant depression.

The punching depth may be comprised between 0.5 and 3 mm, preferably between 0.75 and 2 mm, being of the order of 1 mm for example. The punching depth may depend, for example, on the thickness of the lamination.

It is the movement of the material of the lamination by the punching, creating the punch, that makes it possible to hold the permanent magnet in place. The orientation of the movement of the material of the lamination can be favored by the cutouts located on either side of the tab.

The tabs are present in the housings before the permanent magnets are inserted into them. The tabs are not formed after the permanent magnets have been inserted into the rotor mass.

The permanent magnets may be inserted longitudinally, along the axis of rotation of the rotor, into the corresponding housings.

In the case where the rotor body comprises multiple stacks of laminations stacked one on top of the other, the method may first comprise the step of longitudinally inserting at least one permanent magnet into the recess of each stack of laminations, then the step of stacking the stacks of laminations one on top of the other, with the permanent magnets in the recesses.

### BRIEF DESCRIPTION OF THE DRAWINGS

The described methods and devices will be better understood on reading the following detailed description of non-limiting examples of implementation thereof, and on examining the appended drawing, wherein:

FIG. 1 is a schematic and partial view, in cross section, of an example of a rotor for a rotary electric machine.

FIG. 2 is a detail view thereof.

FIG. 3 is a detail view thereof.

FIG. 4 is a perspective detail view thereof.

FIG. 5 is a view of two laminations of the rotor of FIGS. 1 to 4.

FIG. 6 is a view of two laminations of the rotor of FIGS. 1 to 4, with the permanent magnets.

FIG. 7 is a schematic and partial view, in cross section, of an alternative embodiment.

FIG. 8a is a schematic and partial view, in cross section, of an alternative embodiment.

FIG. 8b is a detail view thereof.

FIG. 8c is a view of a lamination of the rotor of FIGS. 8a and 8b, with the permanent magnets.

FIG. 8d is a perspective detail view thereof.

FIG. 8e is a schematic and partial view, in perspective, of the rotor of FIGS. 8a to 8d.

### DETAILED DESCRIPTION

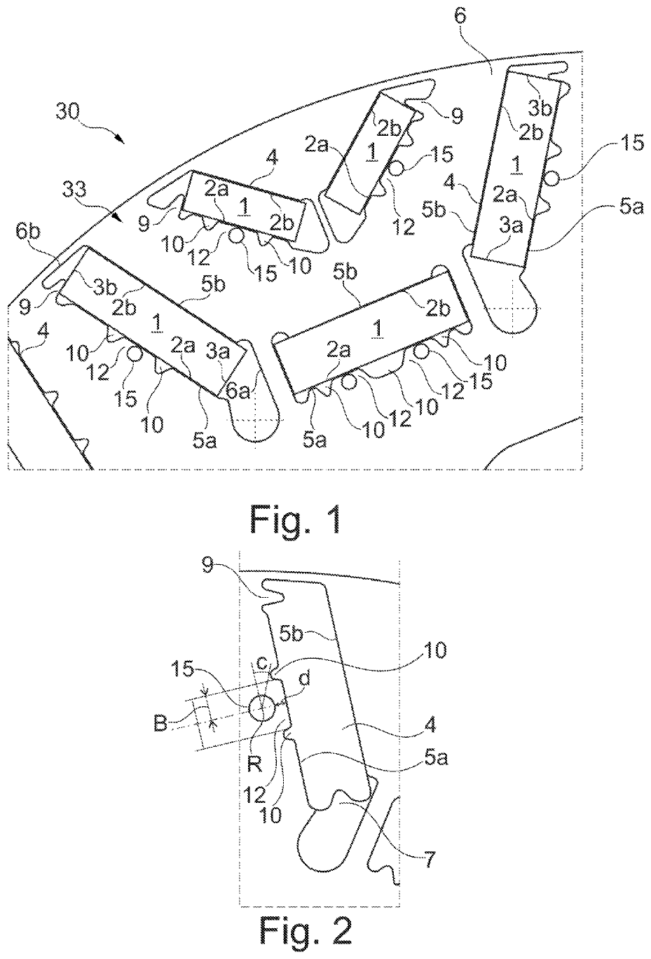

FIGS. 1 to 6 exemplify a rotor 30 for a rotary electric machine, comprising a rotor mass 33 comprising laminations 6 stacked on top of one another and wherein housings 4 are formed. Permanent magnets 1 are inserted into each of the recesses 4.

In this example, the magnets 1 have a generally rectangular cross-sectional shape, as exemplified in FIG. 1. Each magnet 1 has, in cross section, both a first long side 2a and a second long side 2b, opposite the first, and a first short side 3a and a second short side 3b, opposite the first. Each housing 4 is delimited by two faces 5a, 5b facing the first long side 2a and the second long side 2b of the magnet 1, respectively, and by two faces 6a, 6b facing the first short side 3a and the second short side 3b of the magnet 1, respectively.

At least one lamination 6 comprises cutouts 10, two cutouts 10 creating therebetween a tab 12 connecting to said large face 5a of the housing 4 and extending into the housing 4 in the direction of the air gap, as can be seen for example in FIG. 2.

The lamination 6 also comprises a punch 15 formed in a tab 12 and making it possible to hold the permanent magnet 1 against an opposite face 5b of the housing 4. In this example, the tab or tabs 12 have a symmetrical shape with respect to an axis of symmetry, which is an axis of elongation of the tab 12.

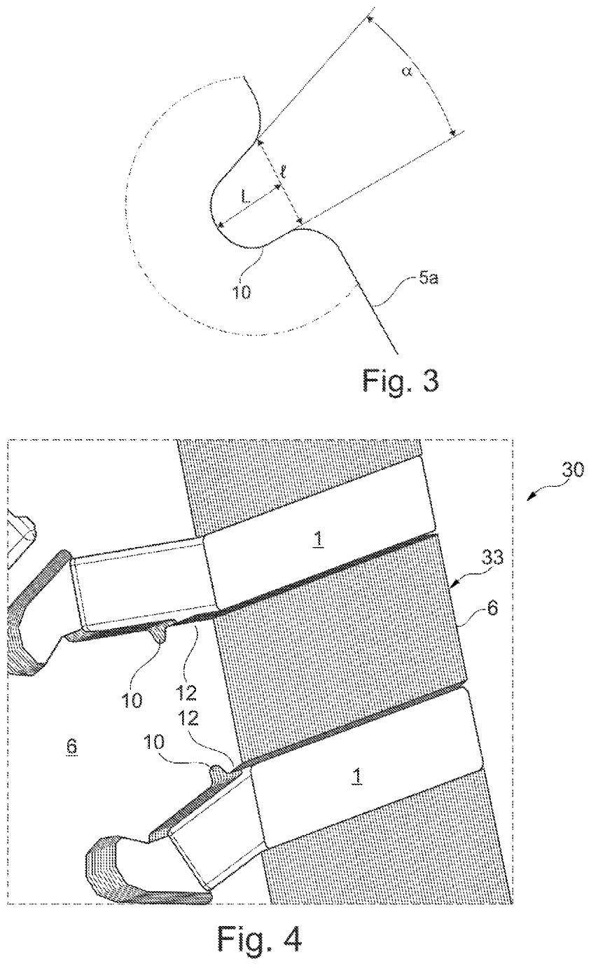

As exemplified in FIG. 3, the cutout 10 is generally V-shaped, with an opening angle α of around 20°, and with a rounded bottom in the shape of a circular arc. The rounded section has a radius of curvature of the order of 0.30 mm or 0.35 mm.

Additionally, the cutout herein is symmetrical with respect to an axis of symmetry, which is an axis of elongation of the cutout. A ratio of the width 1 of a cutout 10 to its length L can be comprised between 1 and 2, being for example of the order of 1.5.

The tab 12 comprises a flat area at the free end thereof. A distance d between the edge of the tab 12 at the flat area and the edge of the punch 15 is, for example, of the order of 0.5 mm.

A half-width B of a tab 12, corresponding to the distance between the center of the tab 12 and the edge of the cutout 10, may be greater than a radius R of the punch 15 plus 1.5 times the thickness e of the lamination 6. This can be written as follows: B>R+1.5 e. The half-width B of a tab 12 is, for example, of the order of 1.5 mm.

An angle C between the line parallel to the edge of the flat area of the tab 12, passing through the center of the punch 15, and the tangent to the bottom of cutout 10 passing through the center of the punch 15 can be of the order of 30°.

In the example shown, the rotor comprises permanent magnets 1 arranged to form poles of the rotor, the cutouts 10 and the punches 15 of one pole of the rotor being arranged symmetrically with respect to one another.

More specifically, the rotor comprises permanent magnets 1 arranged in two rows, one U-shaped and the other V-shaped. In this embodiment, each housing forming the lateral arms of a U or of a V comprises a single tab 12, and each housing forming the bottom of a U comprises two tabs 12.

As exemplified in FIG. 2, the tab 12 is positioned at the center of a face of the corresponding housing 4, in particular at the center of a large face 5a of the housing 4.

Since the lateral housings comprise a single tab, the lateral permanent magnets are held in place with a single punch 15. Since the central housing of one housing row comprises two tabs, the permanent magnet in the middle of the row is held in place by two punches 15. Additionally, the two tabs, which in this case can be located at around one-third and two-thirds of the length of the housing face, are separated by a cutout 10 that is wider than the lateral cutouts.

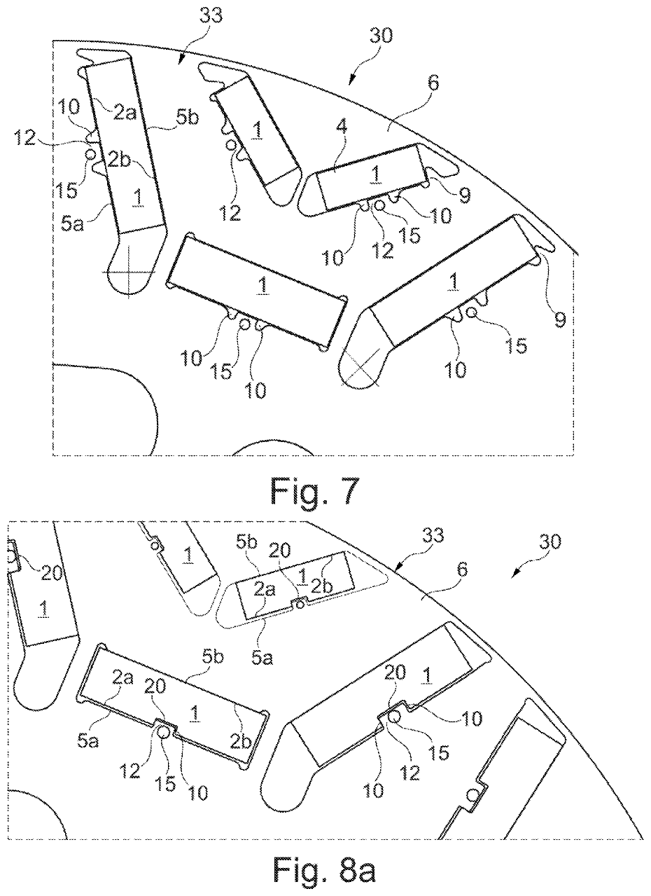

Alternatively, as exemplified in FIG. 7, the central housing of one housing row may comprise a single tab 12. The permanent magnet in the middle of the U-shaped row is held in place by a single punch 15.

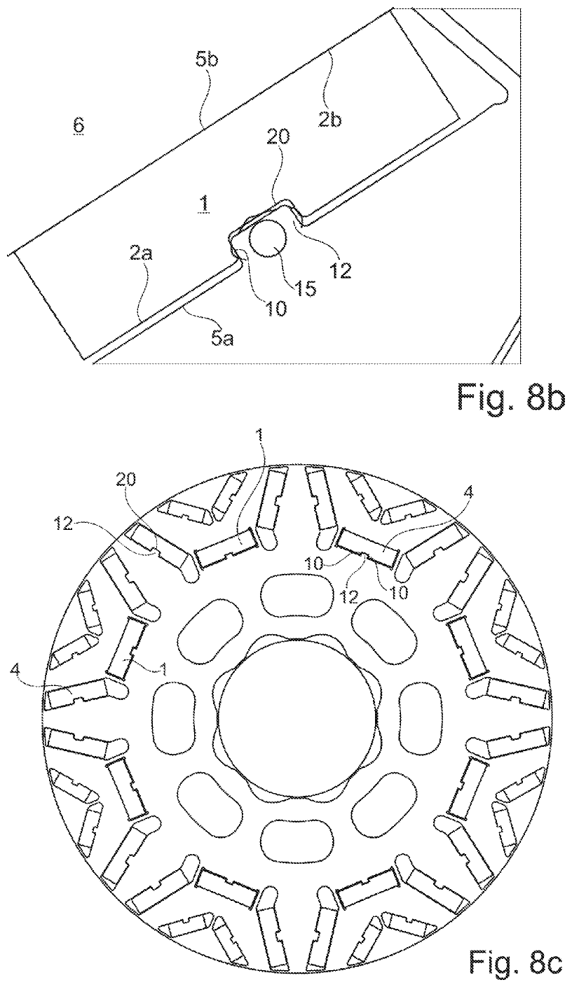

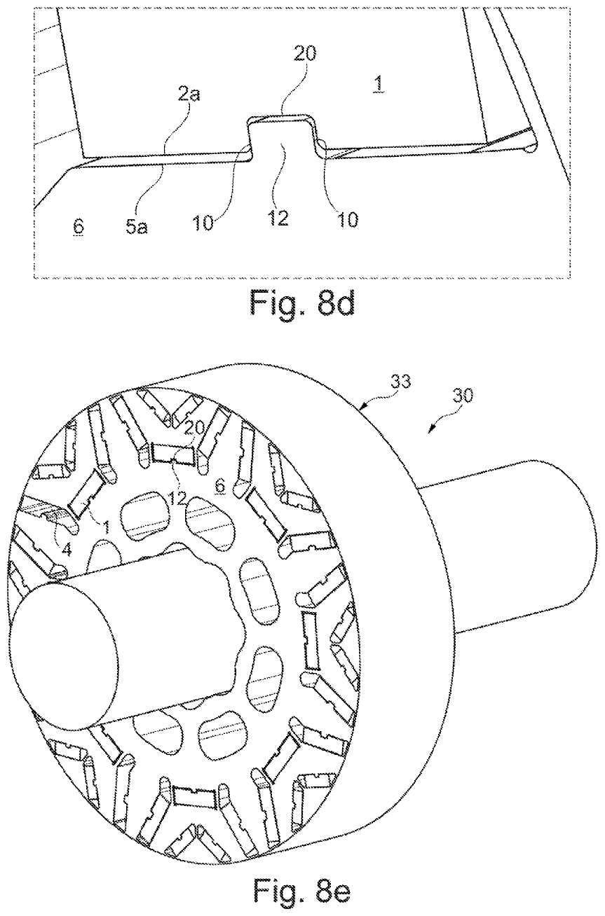

In another alternative embodiment exemplified in FIGS. 8a to 8e, the permanent magnets 1 each comprise a groove 20, in particular over the entire length thereof, said groove 20 being intended to accommodate a tab of the laminations 6 of the rotor mass.

In this configuration, the cutouts 10 are arranged on either side of the tab 12 over all or almost all the length of the housing, and the tab protrudes from a large face 5a of the housing. In particular, the groove 20 is arranged on a long side 2a of the permanent magnet, opposite the air gap, as shown in FIG. 8a. The groove 20 of the permanent magnet extends longitudinally, parallel to an axis of rotation of the rotor, as shown in FIGS. 8d and 8e.

The punch 15 arranged in the tab 12 allows the permanent magnet to be held in three different directions, namely a first direction pushing the permanent magnet toward the air gap, and additionally two directions perpendicular to the first direction, with possible deformation of the tab on three sides thereof, as exemplified in FIG. 8b.

There is no deformation or bending of the tab when the corresponding permanent magnet is inserted, and a clearance may remain between the tab and the permanent magnet in the groove of the latter. During the punching, a deformation of the tab material around the punch is obtained, which can bridge the clearance between the tab and permanent magnet, and immobilize the magnet.

Furthermore, in the example described with reference to FIGS. 1 to 6, at least one lamination 6 of the rotor comprises deformable tongues 7.

A deformable tongue 7 connects to a large face 5a of the central housing, between the two tabs 12 thereof. 11. The tongue 7 extends into the housing 4 in the direction of the air gap, the tongue or tongues 7 making it possible to hold the permanent magnet 1 against the opposite face 5b of the housing 4. In the case that the lamination comprises such a tongue, it may be advantageous for the lamination to comprise two tabs 12, one on either side of the tongue.

Additionally, a deformable tongue 7 connects to a small face 6a of the housing 4 and extends into the housing 4 in the direction of the air gap. This tongue 7 makes it possible to hold the permanent magnet 1 against the opposite face 6b of the housing 4, facing a short side of the permanent magnet.

The lamination 6 also comprises a stop 9 facing the second short side 3b of the permanent magnet 1.

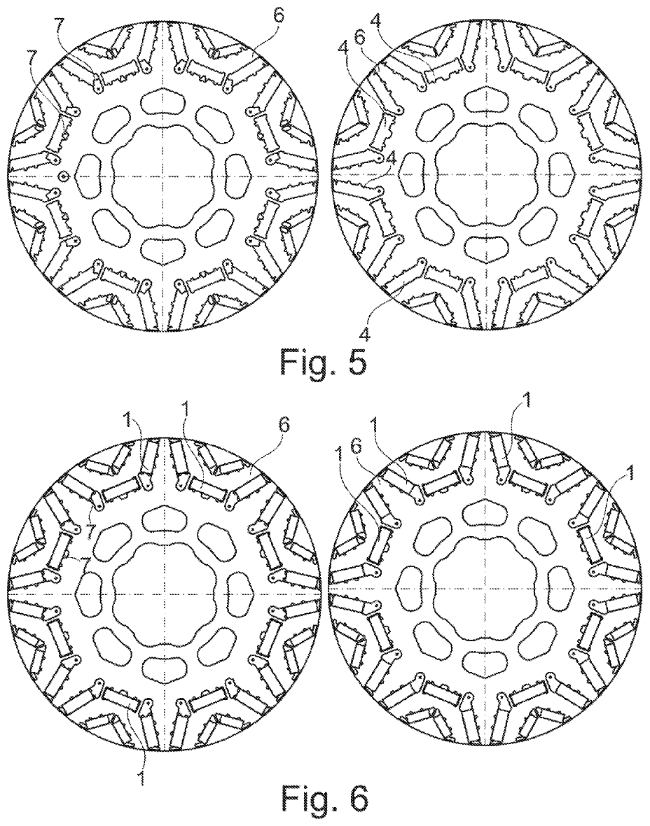

In order to allow the deformation of the deformable tongues 7, the rotor comprises laminations provided with deformable tongues 7, as well as laminations without deformable tongues 7, as exemplified in FIGS. 5 and 6. The various laminations are arranged alternately, so as to allow the deformable tongues 7 to deform outside the plane of the lamination.

Of course, the described methods and devices are not limited to the exemplary embodiments that have just been described.

The rotor mass 33 may have other arrangements of the housings 4 for accommodating the magnets, within the rotor mass.

The recesses 4 and the magnets 1 may take other geometric shapes. The recesses may each extend along a longitudinal axis that may be straight or curved.

In the exemplified embodiments, all the laminations of the rotor mass comprise cutouts and tabs. Therefore, the laminations of the rotor mass may be identical to each other.

Alternatively, the rotor could also comprise laminations without cutouts and tabs, the latter being arranged in particular at the middle of the rotor mass, between two sets of laminations provided with cutouts and tabs.

1. A rotor for a rotary electric machine, comprising:
at least one permanent magnet that has, in cross section, perpendicular to an axis of rotation of the rotor, at least one long side and at least one short side,
a rotor mass comprising stacked laminations, the rotor mass comprising at least one housing accommodating the permanent magnet, the housing being delimited by at least one large face facing a long side of the permanent magnet,
at least one lamination comprising at least two cutouts between them creating at least one tab meeting said large face of the housing and extending into the housing, in particular in the direction of the air gap, the tab or tabs being non-deformable, not deforming outside the plane of the lamination when the permanent magnets are inserted into the rotor mass,
the lamination comprising one or more punches arranged in the tab or tabs and allowing the permanent magnet to be held against an opposite face of the housing, the punch being a deformation of the lamination, which is convex toward the inside of the housing, not being a through-punch.

2. The rotor according to claim 1, wherein the tab or tabs are symmetrical in shape with respect to an axis of symmetry, in particular an axis of elongation of the tab.

3. The rotor according to claim 1, wherein the cutout or cutouts are generally V-shaped, with a rounded bottom.

4. The rotor according to claim 1, wherein the tab or tabs comprise a flat area at the free end thereof.

5. The rotor according to claim 1, wherein the tab or tabs are positioned at the center of a face of the corresponding housing, in particular at the center of a large face of the corresponding housing.

6. The rotor according to claim 1, pwherein at least one permanent magnet comprises a groove, in particular over the entire length thereof, intended to accommodate one or more tabs of laminations of the rotor mass.

7. The rotor according to claim 1, wherein the rotor comprises permanent magnets arranged in one or more rows, in particular in a U-shape or a V-shape.

8. The rotor according to claim 1, wherein the rotor comprises permanent magnets arranged to form poles of the rotor, the cutouts and/or the punches of one pole of the rotor being arranged symmetrically with respect to one another.

9. The rotor according to claim 1, wherein at least one lamination comprises at least one deformable tongue.

10. The rotor according to claim 9, wherein the permanent magnet has, in cross section, a first short side and a second short side, opposite the first, the tongue being configured to press against the first short side of the permanent magnet, at least one lamination comprising at least one stop facing the second short side of the permanent magnet.

11. The rotor according to claim 1, also comprising laminations without cutouts and tabs.

12. The rotor according to claim 1, wherein the housing is delimited by at least one large face facing a long side of the permanent magnet, at least one lamination comprising at least one tongue connected to a large face of the housing and extending into the housing, in particular in the direction of the air gap, the tongue or tongues enabling the permanent magnet to be held against an opposite face of the housing.

13. A rotary electric machine, comprising a stator and a rotor as defined in claim 1.

14. A method for manufacturing a rotor for a rotary electric machine according to claim 1, comprising the following steps:
(a) providing a rotor mass of the rotor comprising housings into which one or more tabs extend each arranged between two cutouts,
(b) inserting permanent magnets into the housings of the rotor mass of the rotor, the tabs not being deformed during this insertion, and
(c) forming one or more punches in the tab or tabs in order to hold the permanent magnet against an opposite face of the housing, the punch being a deformation of the lamination, which is convex toward the inside of the housing, not being a through-punch.
